(19) United States
(12) Patent Application Publication
(10) Pub. No.: US 2015/0062354 A1
(43) Pub. Date: Mar. 5, 2015

(54) METHOD AND SYSTEM FOR CAPTURING IMAGES WITH A FRONT-FACING CAMERA

(71) Applicant: Texas Instruments Incorporated, Dallas, TX (US)

(72) Inventor: Buyue Zhang, Plano, TX (US)

(73) Assignee: Texas Instruments Incorporated, Dallas, TX (US)

(21) Appl. No.: 14/010,801

(22) Filed: Aug. 27, 2013

(51) Int. Cl. H04N 5/232

(52) U.S. Cl. CPC H04N 5/23222; H04N 5/23293
USPC 348/207.1

(57) ABSTRACT

A camera points in a first direction and is positioned within borders of a screen of a display device. The screen faces in a second direction that is substantially parallel to the first direction. While the camera views a scene, the screen displays an image of the viewed scene. While the screen displays the image, the image is written for storage on a computer-readable medium.

### BACKGROUND

The disclosures herein relate in general to image processing, and in particular to a method and system for capturing images with a front-facing camera.

Front-facing cameras are becoming more prevalent in mobile smartphones and tablet computing devices. Also, for laptop and desktop computing devices, webcam accessories have front-facing cameras. A front-facing camera is useful for video conferencing, and for capturing a user's self-portrait, but it may cause an unnatural and/or unpleasant experience.

### SUMMARY

A camera points in a first direction and is positioned within borders of a screen of a display device. The screen faces in a second direction that is substantially parallel to the first direction. While the camera views a scene, the screen displays an image of the viewed scene. While the screen displays the image, the image is written for storage on a computer-readable medium.

### BRIEF DESCRIPTION OF THE DRAWINGS

FIG. 1 is a perspective view of a mobile smartphone that includes an information handling system of the illustrative embodiments.

FIG. 2 is an illustration of an example image captured by a first camera of FIG. 1.

FIG. 3 is an illustration of an example image captured by a second camera of FIG. 1.

FIG. 4 is a plan view of a tablet computing device that includes the information handling system of the illustrative embodiments.

FIG. 5 is an elevation view of a laptop or desktop computing device that includes the information handling system of the illustrative embodiments.

FIG. 6 is a block diagram of the information handling system of the illustrative embodiments.

### DETAILED DESCRIPTION

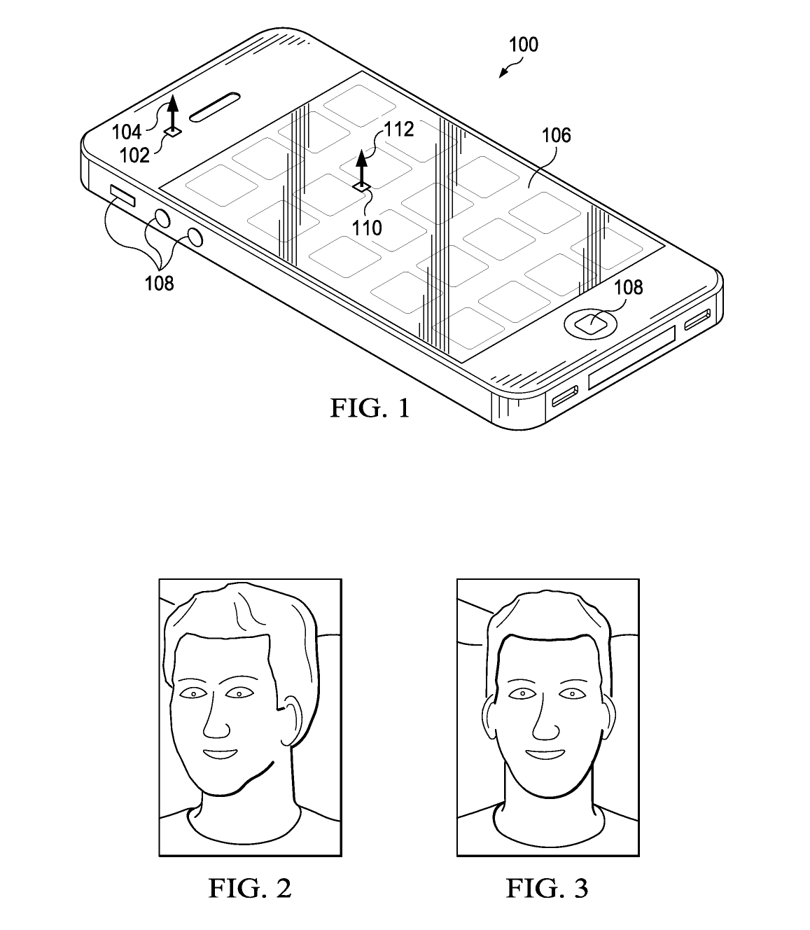

FIG. 1 is a perspective view of a mobile smartphone that includes an information handling system 100 of the illustrative embodiments. In this example, as shown in FIG. 1, the system 100 includes an optional front-facing camera 102 (on a front of the system 100) that points in a direction of an arrow 104 for viewing scenes (e.g., including a physical object and its surrounding foreground and background), capturing and digitizing images of those views, and writing those digitized (or “digital”) images for storage on a computer-readable medium of the system 100 in response to one or more commands from a human user. Also, the system 100 includes a display device 106 (on the front of the system 100) and various switches 108 for manually controlling operations of the system 100.

Moreover, the system 100 includes a front-facing camera 110 (on the front of the system 100) that points in a direction of an arrow 112 for viewing scenes, capturing and digitizing images of those views, and writing those digitized images for storage on the computer-readable medium of the system 100 in response to one or more commands from the user. The arrow 112 is substantially parallel to the arrow 104. Accordingly, a screen of the display device 106 faces in a direction that is substantially parallel to the arrows 104 and 112.

FIG. 2 is an illustration of an example image captured and digitized (and written for storage) by the camera 102 while it views a scene, and while such image is simultaneously displayed by the screen of the display device 106. FIG. 3 is an illustration of an example image captured and digitized (and written for storage) by the camera 110 while it views a scene, and while such image is simultaneously displayed by the screen of the display device 106. Each of those example images shows the user (in the scene) who operates the system 100 to perform those operations, so that the system 100 performs those operations in response to one or more commands from the user.

As shown in FIG. 1: (a) the camera 102 is positioned above the screen, and left of the screen's center; and (b) by comparison, the camera 110 is positioned within the screen's borders, approximately halfway between the screen's left and right borders, and approximately ⅓ of a way between the screen's top and bottom borders. Accordingly, if the user is looking at an image on the screen while such image is being captured, then: (a) as shown in the example image of FIG. 2, while such image is being captured by the camera 102, the user appears to be looking slightly downward and toward the user's right; and (b) as shown in the example image of FIG. 3, while such image is being captured by the camera 110, the user appears to be looking directly at the camera 110.

In one example, the image of FIG. 3 is captured by the camera 110 within a sequence of images during a video conferencing session between the user and a different human participant. If the user is looking at images on the screen during the video conferencing session, then: (a) as shown in the example image of FIG. 3, the camera 110 captures the user appearing to look directly at such participant for a more natural and pleasant experience with an impression of eye contact; and (b) in contrast, as shown in the example image of FIG. 2, the camera 102 would capture the user appearing to look away from such participant for a more unnatural and unpleasant experience without an impression of eye contact.

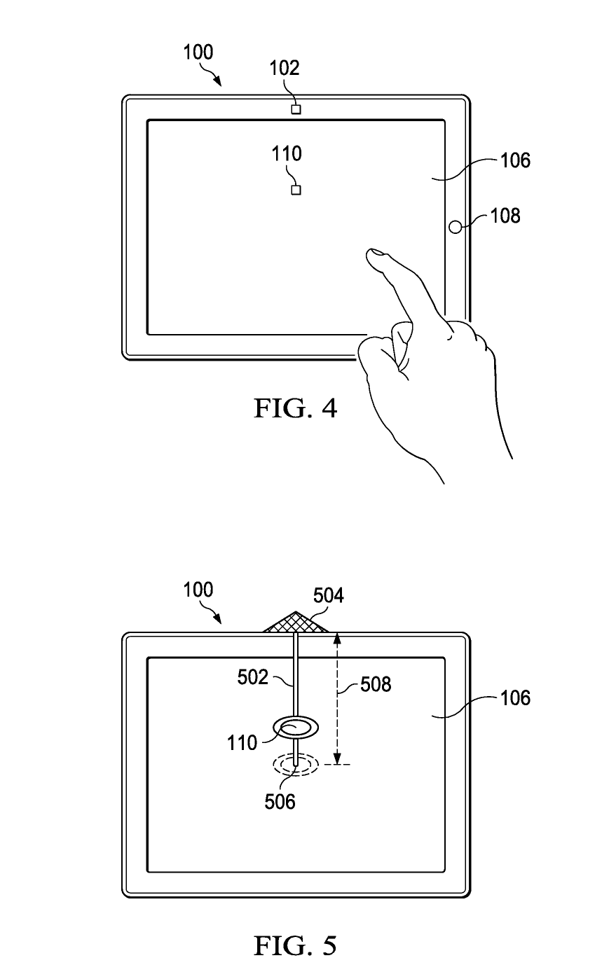

FIG. 4 is a plan view of a tablet computing device that includes the system 100. In the examples of FIGS. 1 and 4, the camera 110 is integral with the screen of the display device 106. For clarity, FIGS. 1 and 4 are not necessarily drawn to scale.

In one embodiment of FIGS. 1 and 4, within the screen of the display device 106, the camera 110 occupies area that is approximately equal to a single pixel of the screen, so the camera 110 is almost invisible to the user. In an example of such embodiment, the camera 110 is optionally hidden by a polymer-dispersed liquid crystal (“PDLC”) surface of the screen, so the PDLC surface is operable to selectively change its opacity in response to an electrical current. In response to the user activating the camera 110 (e.g., by causing the system 100 to execute a particular software application, such as by operating one of the switches 108 to cause such execution, or by touching such application's icon on a touchscreen of the display device 106 to cause such execution), the system 100 automatically supplies the electrical current for causing the PDLC surface to become transparent, thereby enabling the camera 110 to capture images. Conversely, in response to the user deactivating the camera 110, the system 100 automatically removes the electrical current for causing the PDLC surface to become opaque, thereby disabling the camera 110 from capturing images.

FIG. 5 is an elevation view of a laptop or desktop computing device that includes the system 100. In the example of FIG. 5, the camera 110 is separate from the screen of the display device 106. Instead, the camera 110 is adjustably (e.g., slidably) mounted to a railing 502. For clarity, FIG. 5 is not necessarily drawn to scale.

A first end of the railing 502 is connected to a base 504 that sits on top of the system 100, so the railing 502 and the camera 110 hang over the front of the screen. Between the first end of the railing 502 (where the railing 502 connects to the base 504) and a second end 506 of the railing 502, a position of the camera 110 is adjustable (e.g., slidable) by the user, along the railing 502 in either direction of a dashed line 508. Moreover, by the user repositioning the base 504 to sit anywhere on top of the system 100, the position of the camera 110 is adjustable between the screen's left and right borders.

Accordingly, in the example of FIG. 5, the camera 110, the railing 502 and the base 504 together form a webcam accessory, which is connectable to (and detachable from) other components of the system 100. This webcam accessory enables the user to adjustably position the camera 110 (over the front of the screen) within the screen's borders. As shown in FIG. 5, the camera 110 is adjustably positioned (over the front of the screen) within the screen's borders, including: (a) between the screen's left and right borders; and (b) between the screen's top and bottom borders.

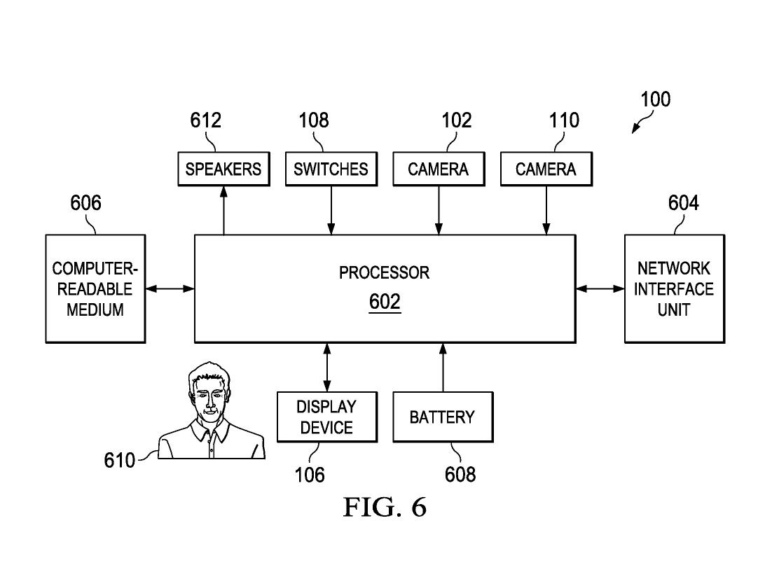

FIG. 6 is a block diagram of the system 100. The system 100 includes various electronic circuitry components for performing the system 100 operations, implemented in a suitable combination of software, firmware and hardware. Such components include: (a) a processor 602 (e.g., one or more microprocessors and/or digital signal processors), which is a general purpose computational resource for executing instructions of computer-readable software programs to process data (e.g., a database of information) and perform additional operations (e.g., communicating information) in response thereto; (b) a network interface unit 604 for communicating information to and from a network in response to signals from the processor 602; (c) a computer-readable medium 606, such as a nonvolatile storage device and/or a random access memory (“RAM”) device, for storing those programs and other information; (d) a battery 608, which is a source of power for the system 100; (e) the display device 106, which includes a screen for displaying information to a human user 610 and for receiving information from the user 610 in response to signals from the processor 602; (f) speakers 612 for outputting sound waves (at least some of which are audible to the user 610) in response to signals from the processor 602; (g) the switches 108; (h) the cameras 102 and 110; and (i) other electronic circuitry for performing additional operations.

As shown in FIG. 6, the processor 602 is connected to the computer-readable medium 606, the battery 608, the display device 106, the speakers 612, the switches 108, and the cameras 102 and 110. For clarity, although FIG. 6 shows the battery 608 connected to only the processor 602, the battery 608 is further coupled to various other components of the system 100. Also, the processor 602 is coupled through the network interface unit 604 to the network (not shown in FIG. 6), such as a Transport Control Protocol/Internet Protocol (“TCP/IP”) network (e.g., the Internet or an intranet). For example, the network interface unit 604 communicates information by outputting information to, and receiving information from, the processor 602 and the network, such as by transferring information (e.g. instructions, data, signals) between the processor 602 and the network (e.g., wirelessly or through a USB interface).

The system 100 operates in association with the user 610. In response to signals from the processor 602, the screen of the display device 106 displays visual images, which represent information, so the user 610 is thereby enabled to view the visual images on the screen of the display device 106. In the embodiments of FIGS. 1 and 4, the display device 106 is housed integrally with the various other components (e.g., electronic circuitry components) of the system 100. In the embodiment of FIG. 5, the display device 106 is housed separately from the cameras 102 and 110, yet housed integrally with the various other components of the system 100.

In one embodiment, the display device 106 is a touchscreen (e.g., the display device 106), such as: (a) a liquid crystal display (“LCD”) device; and (b) touch-sensitive circuitry of such LCD device, so that the touch-sensitive circuitry is integral with such LCD device. Accordingly, the user 610 operates the touchscreen (e.g., virtual keys thereof, such as a virtual keyboard and/or virtual keypad) for specifying information (e.g., alphanumeric text information) to the processor 602, which receives such information from the touchscreen. For example, the touchscreen: (a) detects presence and location of a physical touch (e.g., by a finger of the user 610, and/or by a passive stylus object) within a display area of the touchscreen; and (b) in response thereto, outputs signals (indicative of such detected presence and location) to the processor 602. In that manner, the user 610 can touch (e.g., single tap and/or double tap) the touchscreen to: (a) select a portion (e.g., region) of a visual image that is then-currently displayed by the touchscreen; and/or (b) cause the touchscreen to output various information to the processor 602.

Although illustrative embodiments have been shown and described by way of example, a wide range of alternative embodiments is possible within the scope of the foregoing disclosure.

What is claimed is:

1. A method, comprising:
viewing a scene with a camera, wherein the camera points in a first direction and is positioned within borders of a screen of a display device, and wherein the screen faces in a second direction that is substantially parallel to the first direction;
while viewing the scene with the camera, displaying an image of the viewed scene on the screen; and
while displaying the image on the screen, writing the image for storage on a computer-readable medium.

2. The method of claim 1, wherein the camera is integral with the screen.

3. The method of claim 2, wherein the camera occupies area that is approximately equal to a single pixel of the screen.

4. The method of claim 2, wherein the camera is hidden by a surface of the screen, and wherein the surface is operable to selectively change its opacity.

5. The method of claim 4, and comprising:
in response to a user activating the camera, automatically causing the surface to become transparent; and
in response to the user deactivating the camera, automatically causing the surface to become opaque.

6. The method of claim 1, wherein the camera is: separate from the screen; positioned over a front of the screen; and adjustably positioned within the borders.

7. The method of claim 1, wherein writing the image includes: writing the image for storage on the computer-readable medium in response to a command from a user.

8. The method of claim 7, wherein the image shows the user.

9. The method of claim 1, wherein the borders include top, bottom, left and right borders, and wherein the camera is positioned approximately halfway between the left and right borders.

10. The method of claim 9, wherein the camera is positioned approximately ⅓ of a way between the top and bottom borders.

11. A system, comprising:
a display device including a screen for displaying an image, wherein the screen faces in a first direction; and
a camera for viewing a scene, wherein the camera is positioned within borders of the screen and points in a second direction that is substantially parallel to the first direction, and wherein the screen is for displaying the image of the viewed scene while the camera is viewing the scene; and
a computer-readable medium for storing the image while the screen is displaying the image.

12. The system of claim 11, wherein the camera is integral with the screen.

13. The system of claim 12, wherein the camera occupies area that is approximately equal to a single pixel of the screen.

14. The system of claim 12, wherein the camera is hidden by a surface of the screen, and wherein the surface is operable to selectively change its opacity.

15. The system of claim 14, wherein the display device is for: in response to a user activating the camera, automatically causing the surface to become transparent; and, in response to the user deactivating the camera, automatically causing the surface to become opaque.

16. The system of claim 11, wherein the camera is: separate from the screen; positioned over a front of the screen; and adjustably positioned within the borders.

17. The system of claim 11, wherein the computer-readable medium is for storing the image in response to a command from a user.

18. The system of claim 17, wherein the image shows the user.

19. The system of claim 11, wherein the borders include top, bottom, left and right borders, and wherein the camera is positioned approximately halfway between the left and right borders.

20. The system of claim 19, wherein the camera is positioned approximately ⅓ of a way between the top and bottom borders.
